(19) United States
(12) Patent Application Publication
(10) Pub. No.: US 2014/0204046 A1
(43) Pub. Date: Jul. 24, 2014

(54) CAPACITIVE TOUCH SENSING DEVICE AND DETECTION METHOD THEREOF

(71) Applicant: PIXART IMAGING INC., Hsin-Chu County (TW)

(72) Inventors: En-Feng HSU, Hsin-Chu (TW); Ken CRANDALL, Hsin-Chu (TW); Hsin-Chia CHEN, Hsin-Chu (TW); Ming-Tsan KAO, Hsin-Chu (TW)

(73) Assignee: PIXART IMAGING INC., Hsin-Chu County (TW)

(21) Appl. No.: 13/746,883

(22) Filed: Jan. 22, 2013

(51) Int. Cl. G06F 3/044

(52) U.S. Cl. CPC G06F 3/044
USPC 345/174

(57) ABSTRACT

There is provided a capacitive touch sensing device including a sensing element, a drive unit, a detection circuit and a processing unit. The sensing element has a first electrode and a second electrode configured to form a coupling capacitance therebetween. The drive unit is configured to input a drive signal to the sensing element. The detection circuit is configured to detect a detection signal coupled to the second electrode from the drive signal through the coupling capacitance and to modulate the detection signal respectively with two signals to generate a two-dimensional detection vector. The processing unit identifies a touch event according to the two-dimensional detection vector.

### BACKGROUND

1. Field of the Disclosure

This disclosure generally relates to a touch system and, more particularly, to an active capacitive touch sensing device.

2. Description of the Related Art

Capacitive sensors generally include a pair of electrodes configured to sense a finger. When a finger is present, the amount of charge transfer between the pair of electrodes can be changed so that it is able to detect whether a finger is present or not according to a voltage variation. It is able to form a sensing matrix by arranging a plurality of electrode pairs in matrix.

FIGS. 1A and 1B show schematic diagrams of the conventional capacitive sensor which includes a first electrode 91, a second electrode 92, a drive circuit 93 and a detection circuit 94. The drive circuit 93 is configured to input a drive signal to the first electrode 91. Electric field can be produced between the first electrode 91 and the second electrode 92 so as to transfer charges to the second electrode 92. The detection circuit 94 is configured to detect the amount of charge transfer to the second electrode 92.

When a finger is present, e.g. shown by an equivalent circuit 8, the finger may disturb the electric field between the first electrode 91 and the second electrode 92 so that the amount of charge transfer is reduced. The detection circuit 94 can detect a voltage variation to accordingly identify the presence of the finger.

Principles of the conventional active capacitive sensor may be referred to U.S. Patent Publication No. 2010/0096193 and U.S. Pat. No. 6,452,514.

Referring to FIG. 1C, the detection circuit 94 generally includes a detection switch 941 and a detection unit 942, wherein the detection unit 942 can detect a voltage value on the second electrode 92 only within the on-period of the detection switch 941. However, signal lines of the sensing matrix in different touch panels can have different capacitances, and the drive signal inputted by the drive circuit 93 can have different phase shifts corresponding to different sensing matrices. Therefore, the on-state of the detection switch 941 has to be adjusted corresponding to different touch panels or it is not able to detect correct voltage values. And this adjustment process can increase the manufacturing complexity.

Accordingly, the present disclosure provides a capacitive touch sensing device and a detection method thereof that will not be interfered by the phase shift caused by signal lines.

### SUMMARY

The present disclosure provides a capacitive touch sensing device and a detection method thereof that utilize two continuous signals to respectively modulate a detection signal so as to eliminate the interference from the phase shift caused by signal lines of the sensing matrix.

The present disclosure provides a capacitive touch sensing device including a first electrode, a second electrode, a drive unit, a detection circuit and a processing unit. The first electrode and the second electrode are configured to form a coupling capacitance therebetween. The drive unit is configured to input a drive signal to the first electrode. The detection circuit is coupled to the second electrode and configured to detect a detection signal coupled to the second electrode from the drive signal through the coupling capacitance and to modulate the detection signal respectively with two signals to generate a two-dimensional detection vector. The processing unit is configured to calculate a norm of vector of the two-dimensional detection vector and to compare the norm of vector with a threshold so as to identify a touch event.

The present disclosure further provides a detection method of a capacitive touch sensing device, which includes a sensing element having a first electrode and a second electrode configured to form a coupling capacitance therebetween. The detection method includes the steps of: inputting a drive signal to the first electrode of the sensing element; modulating a detection signal coupled to the second electrode from the drive signal through the coupling capacitance respectively with two signals so as to generate a pair of modulated detection signals; and calculating a scale of the pair of the modulated detection signals to accordingly identify a touch event.

The present disclosure further provides a capacitive touch sensing device that includes a capacitive sensing matrix, a plurality of drive units, a detection circuit and a processing unit. The capacitive sensing matrix includes a plurality of sensing elements arranged in matrix and each of the sensing elements has a first electrode and a second electrode configured to form a coupling capacitance therebetween. The plurality of drive units are coupled to the first electrode of the sensing elements and configured to sequentially output a drive signal to the first electrode. The detection circuit is coupled to the second electrode of the sensing elements and configured to sequentially detect a detection signal coupled to the second electrode from the drive signal through the coupling capacitance and to modulate the detection signal respectively with two signals so as to generate a pair of modulated detection signals. The processing unit is configured to identify a touch event and a touch position according to the pair of the modulated detection signals.

In one aspect, the norm of vector may be calculated by a coordinate rotation digital computer (CORDIC).

In one aspect, the two signals are continuous signals, such as two continuous signals orthogonal or non-orthogonal to each other For example, the two signals may include a sine signal and a cosine signal having a phase difference therebetween equal to, larger than or smaller then zero degree.

In one aspect, the drive signal may be a time-varying signal, such as a periodic signal.

In one aspect, the detection circuit further includes at least one integrator and at least one analog-to-digital converter; the integrator is configured to integrate the detection signal being modulated; and the analog-to-digital converter is configured to digitize the detection signal being modulated and integrated so as to generate two components of the two-dimensional detection vector.

In the capacitive touch sensing device according to the embodiment of the present disclosure, when an object is present close to the sensing element, the norm of vector may become larger or become smaller. Therefore, by comparing the norm of vector with a threshold, it is able to identify that whether the object is present close to the sensing element. And because the norm of vector is a scalar, it is able to eliminate the interference caused by the phase shift of signal lines in the sensing matrix thereby improving the detection accuracy.

### BRIEF DESCRIPTION OF THE DRAWINGS

Other objects, advantages, and novel features of the present disclosure will become more apparent from the following detailed description when taken in conjunction with the accompanying drawings.

FIGS. 1A-1C show schematic diagrams of the conventional active capacitive sensor.

FIG. 2 shows a schematic diagram of the capacitive touch sensing device according to an embodiment of the present disclosure.

FIGS. 3A-3B show other schematic diagrams of the capacitive touch sensing device according to an embodiment of the present disclosure.

FIG. 4 shows a schematic diagram of the norm of vector and the threshold used in the capacitive touch sensing device according to the embodiment of the present disclosure.

FIG. 5 shows a schematic diagram of the capacitive touch sensing device according to another embodiment of the present disclosure.

FIG. 6 shows a flow chart of the operation of the capacitive touch sensing device shown in FIG. 5.

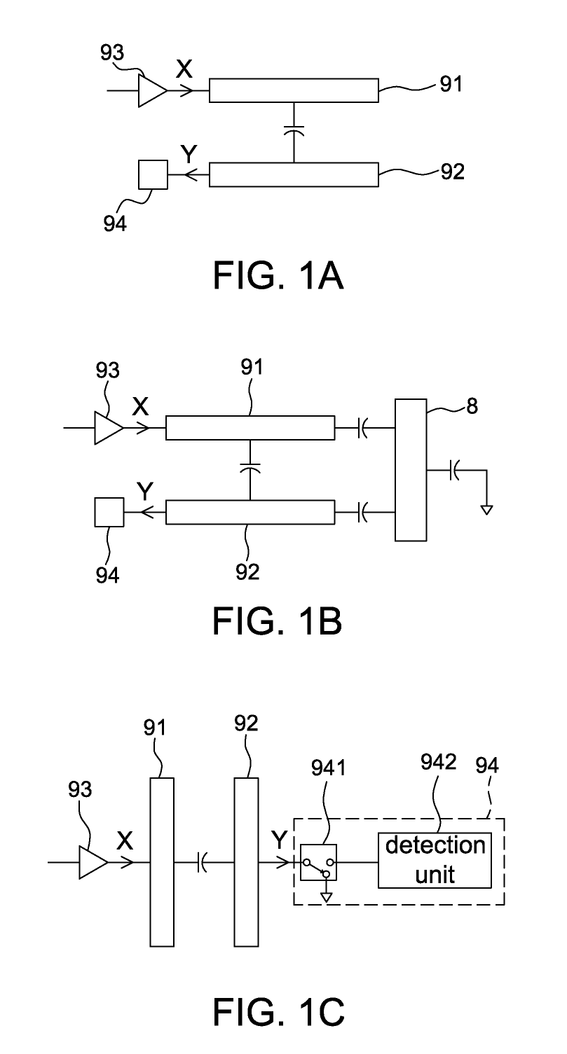

### DETAILED DESCRIPTION OF THE EMBODIMENT

It should be noted that, wherever possible, the same reference numbers will be used throughout the drawings to refer to the same or like parts.

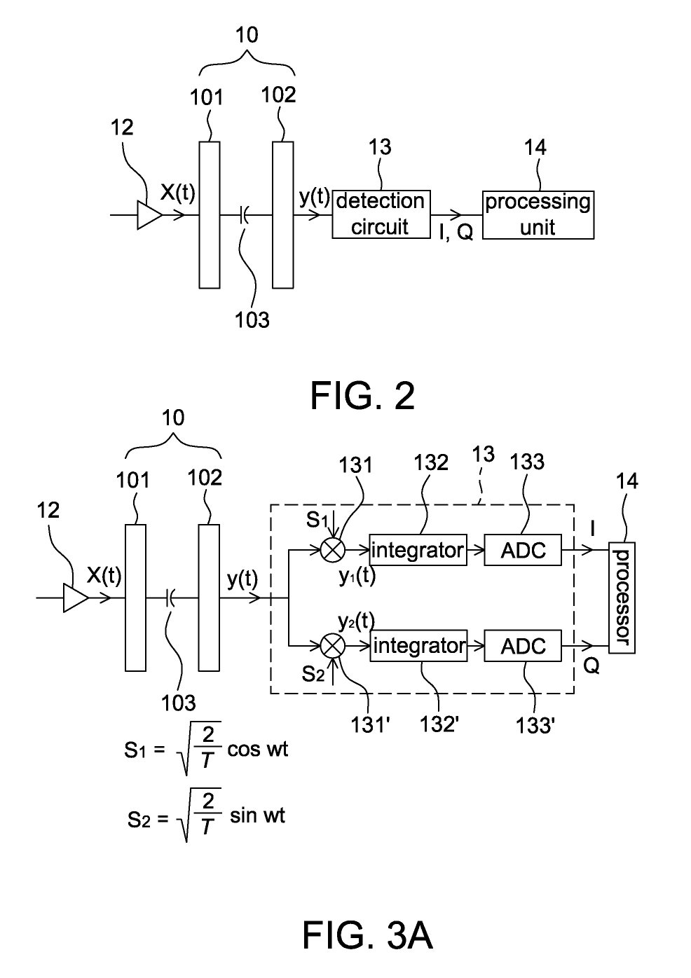

Referring to FIG. 2, it shows a schematic diagram of the capacitive touch sensing device according to an embodiment of the present disclosure. The capacitive touch sensing device of this embodiment includes a sensing element 10, a drive unit 12, a detection circuit 13 and a processing unit 14. The capacitive touch sensing device is configured to detect whether an object (e.g. a finger or a metal plate, but mot limited to) approaches the sensing element 10 according to the change of the amount of charges on the sensing element 10.

The sensing element 10 includes a first electrode 101 (e.g. a drive electrode) and a second electrode 102 (e.g. a receiving electrode), and electric field can be produced to form a coupling capacitance 103 between the first electrode 101 and the second electrode 102 when a voltage signal is inputted to the first electrode 101. The first electrode 101 and the second electrode 102 may be arranged properly without any limitation as long as the coupling capacitance 103 can be formed (e.g. via a dielectric layer), wherein principles of forming the electric field and the coupling capacitance 103 between the first electrode 101 and the second electrode 102 is well know and thus are not described herein. The spirit of the present disclosure is to eliminate the interference on detecting results due to the phase shift caused by the capacitance on signal lines.

The drive unit 12 may be a signal generator and configured to input a drive signal x(t) to the first electrode 101 of the sensing element 10. The drive signal x(t) may be a time-varying signal, such as a periodic signal. In other embodiments, the drive signal x(t) may be a pulse signal, such as a square wave or a triangle wave, but not limited thereto. The drive signal x(t) may couple a detection signal y(t) on the second electrode 102 through the coupling capacitance 103.

The detection circuit 13 is coupled to the second electrode 102 of the sensing element 10 and configured to detect the detection signal y(t) and to modulate the detection signal y(t) respectively with two signals so as to generate a pair of modulated detection signals, which are served as two components I and Q of a two-dimensional detection vector. The two signals may be continuous signals or vectors that are orthogonal or non-orthogonal to each other. In one aspect, the two signals include a sine signal and a cosine signal, wherein a phase difference between the sign signal and the cosine signal may or may not be 0.

The processing unit 14 is configured to calculate a scale of the pair of the modulated detection signals, which is served as a norm of vector of the two-dimensional detection vector (I,Q), and to compare the norm of vector with a threshold TH so as to identify a touch event. In one aspect, the processing unit 14 may calculate the norm of vector R=\sqrt{I²+Q²} by using software. In other aspect, the processing unit 14 may calculate by hardware or firmware, such as using the CORDIC (coordinate rotation digital computer) shown in FIG. 4 to calculate the norm of vector R=\sqrt{i²+q²}, wherein the CORDIC is a well known fast algorithm. For example, when there is no object closing to the sensing element 10, the norm of vector calculated by the processing unit 14 is assumed to be R; and when an object is present nearby the sensing element 10, the norm of vector is decreased to R′. When the norm of vector R′ is smaller than the threshold TH, the processing unit 14 may identify that the object is present close to the sensing element 10 and induces a touch event. It should be mentioned that when another object, such as a metal plate, approaches the sensing element 10, the norm of vector R may be increased. Therefore, the processing unit 14 may identify a touch event occurring when the norm of vector becomes larger than a predetermined threshold.

In another embodiment, the processing unit 14 may perform coding on the two components I and Q of the two-dimensional detection vector by using quadrature amplitude-shift keying (QASK), such as 16-QASK. A part of the codes may be corresponded to the touch event and the other part of the codes may be corresponded to non-touch state and these codes are previously saved in the processing unit 14. When the processing unit 14 calculates the QASK code of two current components I and Q according to the pair of the modulated detection signals, it is able to identify that whether an object is present near the sensing element 10.

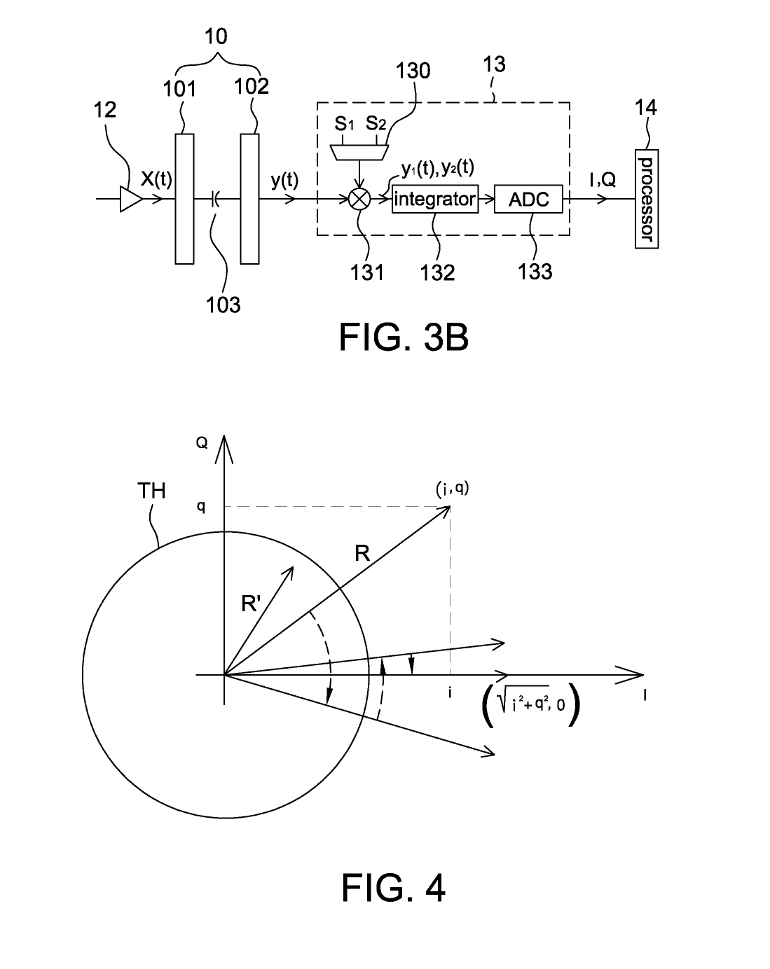

FIGS. 3A and 3B respectively show another schematic diagram of the capacitive touch sensing device according to an embodiment of the present disclosure in which embodiments of the detection circuit 13 are shown.

In FIG. 3A, the detection circuit 13 includes two multipliers 131 and 131′, two integrators 132 and 132′, two analog-to-digital converters (ADC) 133 and 133′ configured to process the detection signal y(t) so as to generate a two-dimensional detection vector (I,Q). The two multipliers 131 and 131′ are indicated to module two signals, such as S₁\sqrt{2/T} cos (ωt) and S₂=\sqrt{2/T} sin(ωt) herein, with the detection signal y(t) so as to generate a pair of modulated detection signals y₁(t) and y₂(t). In order to sample the pair of the modulated detection signals y₁(t) and y₂(t), two integrators 132 and 132′ are configured to integrate the pair of the modulated detection signals y₁(t) and y₂(t). In this embodiment, the two integrators 132 and 132′ may be any proper integration circuit, such as the capacitor. The two ADC 133 and 133′ are configured to digitize the pair of the modulated detection signals y₁(t) and y₂(t) being integrated so as to generate two digital components I and Q of the two-dimensional detection vector. It is appreciated that the two ADC 133 and 133′ start to acquire digital data when voltages on the two integrators 132 and 132′ are stable. In addition to the two continuous signals mentioned above may be used as the two signals, the two signals may also be two vectors, for example S₁=[1 0 -1 0] and S₂=[0 -1 0 1] so as to simplify the circuit structure. The two signals may be proper simplified vectors without any limitation as long as the used vectors may simplify the processes of modulation and demodulation.

In FIG. 3B, the detection circuit 13 includes a multiplier 131, an integrator 132 and an analog-to-digital converter 133, and the two signals S₁ and S₂ are inputted to the multiplier 131 via a multiplexer 130 to be modulated with the detection signal y(t) so as to generate two modulated detection signals y₁(t) and y₂(t). In addition, functions of the multiplier 131, the integrator 132 and the ADC 133 are similar to those shown in FIG. 3A and thus details thereof are not described herein.

As mentioned above, the detection method of the capacitive touch sensing device of the present disclosure includes the steps of: inputting a drive signal to a first electrode of a sensing element; modulating a detection signal coupled to a second electrode from the drive signal through a coupling capacitance respectively with two signals so as to generate a pair of modulated detection signals; and calculating a scale of the pair of the modulated detection signals to accordingly identify a touch event.

Referring to FIGS. 3A and 3B for example, the drive unit 12 inputs a drive signal x(t) to the first electrode 101 of the sensing element 10, and the drive signal x(t) may couple a detection signal y(t) on the second electrode 102 of the sensing element 10 through the coupling capacitance 103. Next, the detection circuit 13 respectively modulates the detection signal y(t) with two signals S₁ and S₂ to generate a pair of modulated detection signals y₁(t) and y₂(t). The processing unit 14 calculates a scale of the pair of the modulated detection signals y₁(t) and y₂(t) to accordingly identify a touch event, wherein the method of calculating the scale of the pair of the modulated detection signals y₁(t) and y₂(t) may be referred to FIG. 4 and its corresponding descriptions. In addition, before calculating the scale of the pair of the modulated detection signals y₁(t) and y₂(t), the integrator 132 and/or 132′ may be used to integrate the pair of the modulated detection signals y₁(t) and y₂(t) and then the ADC 133 and/or 133′ may be used perform the digitization so as to output the two digital components I and Q of the two-dimensional detection vector (I,Q).

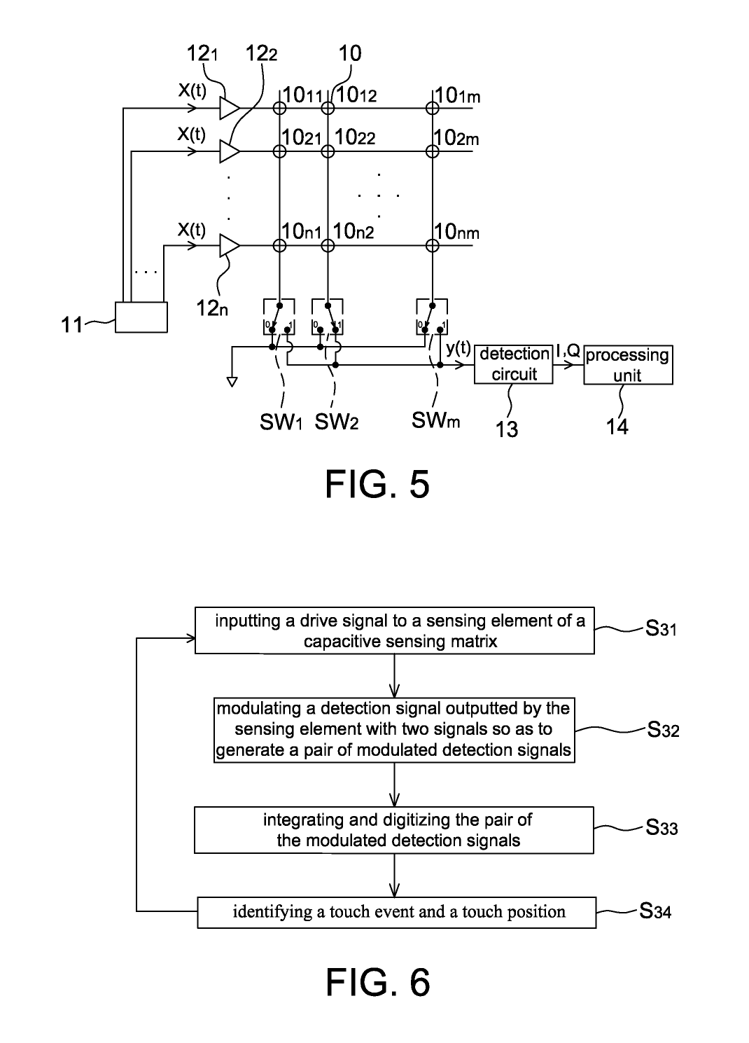

Referring to FIG. 5, it shows a schematic diagram according to another embodiment of the present disclosure. A plurality of sensing elements 10 arranged in matrix may form a capacitive sensing matrix in which every row of the sensing elements 10 is driven by one of the drive units 12₁-12ₙ and the detection circuit 13 detects output signals of every column of the sensing elements 10 through one of the switch devices SW₁-SWₘ. As shown in FIG. 5, the drive unit 12₁ is configured to drive the first row of sensing elements 10₁₁-10₁ₘ; the drive unit 12₂ is configured to drive the second row of sensing elements 10₂₁-10₂ₘ; . . . ; and the drive unit 12ₙ is configured to drive the nth row of sensing elements 10ₙₗ -10ₙₘ; wherein, n and m are positive integers and the value thereof may be determined according to the size and resolution of the capacitive sensing matrix without any limitation.

In this embodiment, each of the sensing elements 10 (shown by circles herein) include a first electrode and a second electrode configured to form a coupling capacitance therebetween as shown in FIGS. 2, 3A and 3B. The drive units 12₁-12ₙ are respectively coupled to the first electrode of a row of the sensing elements 10. A timing controller 11 is configured to control the drive units 12₁-12ₙ to sequentially output a drive signal x(t) to the first electrode of the sensing elements 10.

The detection circuit 13 is coupled to the second electrode of a column of the sensing elements 10 through a plurality of switch devices SW₁-SWₘ to sequentially detect a detection signal y(t) coupled to the second electrode from the drive signal x(t) through the coupling capacitance of the sensing elements 10. The detection circuit 13 utilizes two signals to respectively modulate the detection signal y(t) to generate a pair of modulated detection signals, wherein details of generating the pair of the modulated detection signals has been described in FIGS. 3A and 3B and their corresponding descriptions and thus are not repeated herein.

The processing unit 14 identifies a touch event and a touch position according to the pair of the modulated detection signals. As mentioned above, the processing unit 14 may calculate a norm of vector of a two-dimensional detection vector of the pair of the modulated detection signals and identifies the touch event when the norm of vector is larger than or equal to, or smaller than or equal to a threshold TH as shown in FIG. 4.

In this embodiment, when the timing controller 11 controls the drive unit 12₁ to output the drive signal x(t) to the first row of the sensing elements 10₁₁-10₁ₘ, the switch devices SWₗ-SWₘ, are sequentially turned on such that the detection circuit 13 may detect the detection signal y(t) sequentially outputted by each sensing element of the first row of the sensing elements 10₁₁-10₁ₘ. Next, the timing controller 11 sequentially controls other drive units 122-12n to output the drive signal x(t) to every row of the sensing elements. When the detection circuit 13 detects all of the sensing elements once, a scan period is accomplished. The processing unit 14 identifies the position of the sensing elements that the touch event occurs as the touch position. It is appreciated that said touch position may be occurred on more than one sensing elements 10 and the processing unit 14 may take all positions of a plurality of sensing elements 10 as touch positions or take one of the positions (e.g. the center or gravity center) of a plurality of sensing elements 10 as the touch position.

Referring to FIG. 6, it shows a flow chart of the operation of the capacitive sensing device shown in FIG. 5, which includes the steps of: inputting a drive signal to a sensing element of a capacitive sensing matrix (Step S₃₁); respectively modulating a detection signal outputted by the sensing element with two signals so as to generate a pair of modulated detection signals (Step S₃₂); integrating and digitizing the pair of the modulated detection signals (Step S₃₃); and identifying a touch event and a touch position (Step S₃₄). Details of the operation of this embodiment have been described in FIG. 5 and its corresponding descriptions and thus are not repeated herein.

In another aspect, in order to save the power consumption of the capacitive touch sensing device shown in FIG. 5, the timing controller 11 may control more than one drive units 12₁-12ₙ to simultaneously output the drive signal x(t) to the associated row of the sensing elements. The detection unit 13 respectively modulates the detection signal y(t) of each row with different two continuous signals S₁ and S₂ for distinguishing. In addition, the method of identifying the touch event and the touch position are similar to FIG. 5 and thus details thereof are not repeated herein.

In the embodiment of the present disclosure, the detection circuit 13 may further include the filter and/or the amplifier to improve the signal quality. In addition, the processing unit 14 may be integrated with the detection circuit 13.

As mentioned above, the conventional active capacitive sensor has to be adjusted corresponding to different touch panels in order to correctly detect the voltage signal such that it has a higher manufacturing complexity. Therefore, the present disclosure further provides a capacitive touch sensing device (FIGS. 2, 3A and 3B) and a detection method thereof (FIG. 6) that utilize two continuous signals to respectively modulate a detection signal and identify a touch event according to a norm of vector of the detection signal being modulated (FIG. 4) so as to eliminate the interference from the phase shift caused by signal lines of the sensing matrix and simplify the manufacturing process.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

What is claimed is:

1. A capacitive touch sensing device, comprising:
a first electrode and a second electrode configured to form a coupling capacitance;
a drive unit configured to input a drive signal to the first electrode;
a detection circuit, coupled to the second electrode, configured to detect a detection signal coupled to the second electrode from the drive signal through the coupling capacitance and to modulate the detection signal respectively with two signals to generate a two-dimensional detection vector; and
a processing unit configured to calculate a norm of vector of the two-dimensional detection vector and to compare the norm of vector with a threshold so as to identify a touch event.

2. The capacitive touch sensing device as claimed in claim 1, wherein the two signals are continuous signals orthogonal to each other.

3. The capacitive touch sensing device as claimed in claim 1, wherein the two signals include a sine signal and a cosine signal.

4. The capacitive touch sensing device as claimed in claim 1, wherein the processing unit calculates the norm of vector using CORDIC.

5. The capacitive touch sensing device as claimed in claim 1, wherein the drive signal is a periodic signal.

6. The capacitive touch sensing device as claimed in claim 1, wherein the detection circuit further comprises at least one integrator and at least one analog-to-digital converter; the integrator is configured to integrate the detection signal being modulated; and the analog-to-digital converter is configured to digitize the detection signal being modulated and integrated so as to generate two components of the two-dimensional detection vector.

7. A detection method of a capacitive touch sensing device, the capacitive touch sensing device comprising a sensing element, which comprises a first electrode and a second electrode configured to form a coupling capacitance, the detection method comprising:
inputting a drive signal to the first electrode of the sensing element;
modulating a detection signal coupled to the second electrode from the drive signal through the coupling capacitance respectively with two signals so as to generate a pair of modulated detection signals; and
calculating a scale of the pair of the modulated detection signals to accordingly identify a touch event.

8. The detection method as claimed in claim 7, wherein the scale of the pair of the modulated detection signals is a norm of vector of a two-dimensional vector formed by the pair of the modulated detection signals.

9. The detection method as claimed in claim 8, wherein the norm of vector is calculated by using CORDIC.

10. The detection method as claimed in claim 7, wherein the two signals include a sine signal and a cosine signal.

11. The detection method as claimed in claim 7, wherein the two signals are continuous signals orthogonal to each other.

12. The detection method as claimed in claim 7, wherein the drive signal is a periodic signal.

13. The detection method as claimed in claim 7, wherein before the step of calculating a scale of the pair of the modulated detection signals further comprises:
integrating and digitizing the pair of the modulated detection signals.

14. A capacitive touch sensing device, comprising:
a capacitive sensing matrix comprising a plurality of sensing elements arranged in matrix and each of the sensing elements comprising a first electrode and a second electrode configured to form a coupling capacitance;
a plurality of drive units, coupled to the first electrode of the sensing elements, configured to sequentially output a drive signal to the first electrode;
a detection circuit, coupled to the second electrode of the sensing elements, configured to sequentially detect a detection signal coupled to the second electrode from the drive signal through the coupling capacitance and to modulate the detection signal respectively with two signals so as to generate a pair of modulated detection signals; and
a processing unit configured to identify a touch event and a touch position according to the pair of the modulated detection signals.

15. The capacitive touch sensing device as claimed in claim 14, wherein the two signals are continuous signals orthogonal to each other.

16. The capacitive touch sensing device as claimed in claim 14, wherein the two signals include a sine signal and a cosine signal.

17. The capacitive touch sensing device as claimed in claim 14, wherein the drive signal is a periodic signal.

18. The capacitive touch sensing device as claimed in claim 14, wherein the processing unit calculates a norm of vector of a two-dimensional detection vector formed by the pair of the modulated detection signals and identifies the touch event occurs when the norm of vector is smaller than or larger than a threshold.

19. The capacitive touch sensing device as claimed in claim 18, wherein the processing unit calculates the norm of vector using CORDIC.

20. The capacitive touch sensing device as claimed in claim 14, wherein the processing unit identifies a position of at least one of the sensing elements occurring the touch event within a scan period as the touch position.
